(19) United States
(12) Patent Application Publication
(10) Pub. No.: US 2005/0071863 A1
(43) Pub. Date: Mar. 31, 2005

(54) System and method for storing and distributing television viewing patterns form a clearinghouse

(76) Inventors: William R. Matz, Atlanta, GA (US); Scott R. Swix, Duluth, GA (US)

Correspondence Address: MERCHANT & GOULD PC, P.O. BOX 2903, MINNEAPOLIS, MN, 55402-0903, US

(21) Appl. No.: 10/037,005

(22) Filed: Dec. 21, 2001

(51) Int. Cl. H04N 7/16; H04N 7/10; H04N 7/025; H04H 9/00

(52) U.S. Cl. 725/9; 725/15; 725/35

(57) ABSTRACT

A method for receiving and distributing content-choice information includes collecting subscriber content-choice data from a plurality of subscriber content-choice databases and storing the subscriber content-choice data in a clearinghouse database. The stored subscriber content-choice data may selected and provided to a requesting party. A system for receiving and distributing content-choice information comprises a content-choice information clearinghouse and a plurality of subscriber content-choice databases.

### CROSS-REFERENCE TO RELATED APPLICATIONS

This application relates to Attorney Docket No. 36968-265386 (BS01341), filed by Matz et al. on Dec. 14, 2001, entitled “System and Method for Utilizing Television Viewing Patterns,” which is incorporated herein by reference. This application also relates to Attorney Docket No. 36968-265387 (BS01342) filed by Matz et al. on Dec. 14, 2001, entitled “System and Method for Identifying Desirable Subscribers,” which is incorporated herein by reference. This application also relates to U.S. application Ser. No. 09/496,825, filed Feb. 1, 2000, which is incorporated herein by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### FIELD OF THE INVENTION

The present invention generally relates to the storage and distribution of television viewing patterns in a clearinghouse and, in particular, to the collection, storage, and utilization of television viewing patterns received from cable system operators in different locations.

### BACKGROUND

Television programming providers, such as television networks and cable television companies, derive income from various sources. One source of revenue for the programming providers is advertising revenue. If a television program cannot produce at least as much revenue as it costs to produce the program, the provider will generally cancel the program.

Conventionally, advertising revenue equals a rate per thousand viewers 110 multiplied by the number of viewers estimated to be watching a program. Therefore, the higher the number of viewers, the greater the revenue programming providers derive from a program.

If a program is popular, i.e., many viewers are watching it, a programming provider charges a higher advertising rate for advertising appearing during the program's commercial breaks than the programming provider is able to charge for less popular programming. Therefore, programming providers are very interested in determining the popularity of a program.

In addition, a program scheduled adjacent to a popular program or between two popular programs may attain a higher level of popularity than it might achieve without such opportune scheduling. Therefore, programming providers are interested in determining the interrelationships between various combinations of programming as well as between various combinations of programming and advertising.

Programming providers conventionally utilize various methods to evaluate a program's popularity and to evaluate the interrelationships between the program and other programming or advertising. For example, a programming provider may implement a program of voluntary logging of television viewing by a viewer, followed by transmission and human processing to analyze the information contained in the log. In addition, a programming provider may utilize telephone, mail, or other types of surveys to inquire from random or selected viewers about the viewers' viewing habits and request their recollections regarding their viewing patterns. A programming provider may also utilize automated monitoring systems that attempt to intercept television channel choices and changes, record these events, and provide the recording to a clearinghouse or other facility for further processing.

The provider may enlist a ratings company to perform the monitoring and processing. For example, Nielsen Media Research (Nielsen Media Research, Inc., New York, N.Y.), Arbitron (Arbitron Inc., New York, N.Y.), and MeasureCast (MeasureCast, Inc., Portland, Oreg.) provide third-party monitoring and processing capability.

The Nielsen Media Research (Nielsen) Ratings are perhaps the best known of the various third-party ratings services. Nielsen utilizes a variety of conventional sampling methods to determine the number of viewers watching a particular show. For example, in five thousand homes, Nielsen installs a People Meter. The People Meter records viewing patterns from television sets, cable television set-top boxes, videocassette recorders, satellite television set-top boxes, and other sources of video programming. The People Meter records what content the particular device is providing on an ongoing basis and periodically transmits this information to servers within a Nielsen facility. Nielsen combines the data uploaded from the People Meter with media content data to determine what programming and advertising a device displayed. Nielsen uses the combined data to provide a rating for each program and advertisement. In conjunction with the People Meter, Nielsen also utilizes viewer diaries and surveys to gather information from a broader spectrum of television viewers and to confirm the results generated by the People Meter.

Arbitron Inc. (Arbitron) is well known for providing radio broadcast ratings. Arbitron compiles ratings by utilizing surveys. Arbitron also provides television ratings based on various sampling techniques. In cooperation with Nielsen, Arbitron has developed a Portable People Meter to measure television ratings. The Portable People Meter is a pager-sized device, worn by a participant in a survey. The Portable People Meter records viewing by recording sounds encoded into each broadcast, which identify the program or advertisement. The survey participant periodically plugs the Portable People Meter into a recharger, which also includes a communicator that uploads the data in the Portable People Meter into a remote Arbitron server. The Portable People Meter may be a more accurate method of television ratings than a set-top box, such as the set-top box used by Nielsen. The Portable People Meter offers the advantage of capturing viewing outside of the home and of recognizing when the viewer is not within audible range of a television, and therefore, less likely to be viewing a particular program or advertisement.

As the use of the Internet increases, the distribution of programming via Internet channels becomes more important. MeasureCast, Inc. (MeasureCast) provides a ratings system for Internet media streaming. MeasureCast records the number of streams requested from a streaming server and provides reports to programming providers and advertisers detailing the popularity of particular streams. As is the case in traditional broadcast media, the more popular the stream, the higher the advertising rate a broadcaster is able to charge.

Nielsen, Arbitron, and MeasureCast provide direct methods of measuring the popularity of a program. Various indirect methods are also used to determine the popularity of programming and the effectiveness of advertising. For example, advertising effectiveness is often measured in terms of viewer attitudes and subsequent viewer actions, such as purchases, inquiries, behavior changes, and other actions. Methods of obtaining these indirect measures include: focus group tests, post-advertising surveys questioning whether an advertisement was viewed, remembered and possible impact, and measures of product purchases or other indirect results that may indicate whether or not an advertising campaign has been successful.

Conventional methods to determine television viewer patterns and preferences are inefficient and not well suited to immediate, timely use for any content-customization applications. In addition, conventional systems, such as the Nielsen and Arbitron meters rely on small samples, which may not be representative of the target market for a particular advertiser.

Also, surveys are expensive and highly dependent on identifying individuals that may have been viewing television at the time of the advertisement. And post advertising results measurements suffer from questions of causality and external influences. Focus groups allow reasonably efficient low-volume viewer analysis, but statistical analysis requires an adequate number of participants and tightly controlled tests, a combination that may be difficult to achieve.

Conventional systems and methods do not provide simple, effective, and efficient means for determining genre-choice preferences in terms of programming or advertising. The systems also lack simple and efficient methods of determining the duration of viewing patterns, especially as those patterns are affected by the genre-type of a program or advertisement, the time-of-day of a broadcast, and the programming and/or advertising preceding and/or succeeding the program.

It would be desirable to provide simple, effective, and efficient means for combining viewing patterns and viewer preferences from a plurality of media operators (e.g., cable system operators) in various locations to be made available to requesting parties (e.g., advertisers and media content providers) for various purposes. It would also be desirable to provide selected viewing patterns and viewer preferences from a plurality of media operators in various locations to be made available to requesting parties for various purposes.

### SUMMARY

The present invention provides systems and methods for effectively and efficiently receiving, analyzing, and distributing content-choice information for subscribers of television and/or other media services. Content-choice information includes, for example, information relating to the actual viewing activities of subscribers, subscriber viewing preference information, and subscriber viewing pattern information. For example, content-choice information may include information as specific as the fact that a subscriber watched a situation comedy on a particular network from 8:00 p.m. to 8:30 p.m., but switched to a college basketball game on a cable sports network when the situation comedy went to commercials. Another example of content-choice information would relate to viewer pattern information, such as the fact that particular viewer watched a particular television channel at the same time on the same day every week.

An embodiment of a system for receiving and distributing content-choice information comprises a content-choice information clearinghouse. The clearinghouse receives subscriber content-choice data and provides selected subscriber content-choice data to a requesting party. The clearinghouse may receive the subscriber content-choice data from a plurality of subscriber content-choice databases. For example, each cable system operator that provides data to the clearinghouse may have its own subscriber content-choice database at its head-end facility.

In one embodiment, the clearinghouse comprises a database and a processor. The database stores and sorts the subscriber content-choice data. The processor receives a request for selected subscriber content-choice data from a requesting party. Examples of requesting parties include, for example, television content providers, advertisers, and marketing firms. The processor retrieves and compiles the selected subscriber content-choice data from the database and provides it to the requesting party over the Internet.

Subscriber content-choice data may include data relating to the subscriber (e.g., the viewer or user), data relating to the subscriber system (e.g., the cable or satellite system operator), data relating to the programming viewed by the subscriber (e.g., the television programs), data relating to the advertising viewed by the subscriber, data relating to the viewing preferences of the subscriber, and data relating to the viewing patterns of the subscriber. Specifically, the subscriber content-choice data may include, for example, subscriber names, subscriber identification numbers/codes, subscriber geographic locations, subscriber demographic information (age, sex, race, religion, income, occupation, etc.), subscriber system names (e.g., cable system names), subscriber system locations, subscriber system identification numbers/codes, date identifiers, time identifiers, television program data (e.g., program name, genre, network/cable/premium program, etc.), advertisement data (manufacturer, brand, commercial length), radio program data, and Internet program data. The subscriber content-choice data may be in the form of subscriber content-choice records.

Subscriber content-choice data may also include subscriber content-choice summary data, such as data relating to the viewing preferences of the subscriber, data relating to the viewing preferences of a plurality of subscribers, data relating to the viewing patterns of the subscriber, and data relating to the viewing patterns of a plurality of subscribers. A classification or category system may be established such that subscribers are assigned classifications or categories based on their past viewing histories. The classification system may include primary classifications and sub-classifications. For example, a subscriber who watches sports programming during 40% of his viewing time may have a primary classification of “Sports.” If the subscriber watches situation comedies during another 25% of his viewing time, his first sub-classification may be “Situation Comedy.” These classifications or subscriber categories are additional examples of subscriber content-choice summary data. When subscriber content-choice data is received from a plurality of subscriber content-choice databases, a standardized classification system is preferably used.

In another embodiment, a system of the present invention for receiving and distributing content-choice information comprises a content-choice information clearinghouse and a plurality of subscriber content-choice databases. The clearinghouse collects subscriber content-choice data from the plurality of subscriber content-choice databases and stores the subscriber content-choice data. The clearinghouse may comprise a clearinghouse database and a clearinghouse processor.

In a further embodiment, the system also comprises a content provider terminal. For example, a content provider, such as a television content provider or an advertiser, may request certain subscriber content-choice data from the clearinghouse. The content provider may submit its request to the clearinghouse over the Internet using the content provider terminal. The clearinghouse processor may then provide the selected subscriber content-choice data to the content provider terminal over the Internet after retrieving and compiling the selected subscriber content-choice data from the clearinghouse database.

The present invention also relates to methods for receiving and distributing subscriber content-choice information. An embodiment of a method for receiving subscriber content-choice information comprises collecting subscriber content-choice data from a plurality of subscriber content-choice databases, and storing the subscriber content-choice data in a clearinghouse database. In a further embodiment, the clearinghouse database may sort the collected subscriber content-choice data.

An embodiment of the present invention provides numerous advantages over conventional systems for using subscriber content-choice information in evaluating programming and advertising content. It is difficult and inefficient in conventional systems to determine television viewer category or genre preferences, e.g., sports, shopping, and/or other broad advertisement categories, in particular markets or regions. Also, the category or genre preference may be further sub-categorized, e.g., college basketball, home theater, or other more detailed category, creating greater inefficiency in determining viewer preferences. The clearinghouse provided in an embodiment of the present invention is useful for subscriber content-choice reporting, automated targeting of advertising, promotions, etc. based upon viewer category or genre-choice preferences.

It is difficult and inefficient in conventional systems to determine the specific time-of-day viewing patterns of subscribers, including, for example, statistically significant trends for limited time viewing before weekday commutes, limited time viewing during meal hours, etc. In an embodiment of the present invention, information associated with the time of day during which customers view television will be valuable for certain day part analysis used by networks to determine high-value (e.g. high-probability of impression) timeframes within programs for various marketing, advertising and other purposes.

It is difficult and inefficient in conventional systems to determine the viewing patterns of behaviors associated with viewer choices regarding programs prior to or following a program in question. For example, the tendency of customers to terminate sports programming which follows or precedes news programming may be valuable information for a program provider. Also, information associated with the probability of continued viewing of programming content following a specific category or genre of programming is valuable for certain day part analysis used by networks to determine high-value, e.g., high-probability of impression, timeframes within programs for various marketing, advertising and other purposes.

It is difficult and inefficient in conventional systems to determine the viewing patterns of behaviors associated with viewer choices regarding the broad advertisement content categories occurring in groups of programming which a viewer observes. For example, it is difficult to determine the tendency of subscribers who watch sequences of consecutive programming to terminate non-sports programming when non-sports programming intervenes within a grouping of sports viewing. In an embodiment of the present invention, reports provide information for advertisers as well as program providers. For example, sorted data of successful advertising impressions for all subscribers in any number of locations or regions may be combined to present a highly accurate analysis of the success of advertising impressions based upon the categories or genres or time-of-day in which the advertising was shown.

It is difficult and inefficient in conventional systems to determine whether advertising viewers continue to view an entire advertisement or “channel hop” to other programming. For example, whether subscribers view luxury car advertisements throughout the full duration of a thirty-second spot and/or whether subscribers immediately terminate the soft drink advertising spots.

It is difficult and inefficient in conventional systems to determine whether advertising viewers have a higher or lower probability of viewing or terminating advertisements based upon the content of the directly preceding or following programs. It is also difficult and inefficient in conventional systems to determine whether advertising viewers have a higher or lower probability of viewing or terminating advertisements based upon the consistency and content of genres of programming presented in a multiple program sequence over a specified time interval preceding or subsequent to the advertisement. In an embodiment of the present invention, various standardized and customized reports provide data to address these issues.

It is also difficult and inefficient in conventional systems to determine the relative strengths of competitive advertising. In an embodiment of the present invention, specific analysis may be performed to compare advertising effectiveness against competitive advertising campaigns.

The present invention also advantageously provides for the combining of viewer preferences and viewer patterns from various systems to provide additional value to content providers, advertisers, networks, cable television networks and other interested parties. For example, advertisers can focus on data from an entire market rather than just data from particular cable system.

The methods and systems of the present invention also advantageously provide for the simple aggregation of data associated with individual subscribers. The present invention may also be advantageously implemented for both domestic and international applications.

The methods and systems of the present invention advantageously increase the efficiency relating to the storage and use of data associated with individual subscribers. For example, by using a clearinghouse, cable system operators need not store the data long term or provide access to it after the data are collected by the clearinghouse.

Further details and advantages of the present invention are set forth below. Additional uses, objects, advantages, and novel features of the invention are set forth in the detailed description that follows and will become more apparent to those skilled in the art upon examination of the following or by practice of the invention.

### BRIEF DESCRIPTION OF THE FIGURES

FIG. 1 is a schematic of an embodiment of the present invention for collecting content-choice information;

FIG. 2 illustrates the contents of an extensible markup language (XML) file containing subscriber content-choice data that may be collected by a clearinghouse in one embodiment of the present invention;

FIG. 3 is a schematic of an embodiment of the present invention for providing content-choice information to a content provider; and

FIG. 4 is a schematic of an embodiment of the present invention for collecting content-choice information at a clearinghouse and providing content-choice information to content providers.

### DETAILED DESCRIPTION

Embodiments of the present invention provide systems and methods for effectively and efficiently collecting, storing, combining, categorizing, analyzing, and providing subscriber content-choice information, such as television viewing patterns. In an embodiment of the present invention, subscriber content-choice data are collected from a plurality of system operators (e.g., cable system operators), each having a subscriber content-choice database. The subscriber content-choice data are stored in a clearinghouse. The clearinghouse is able to provide the data, summaries of the data, and/or analyses of the data to a requesting party, such as a content provider or an advertiser. The requesting party can request specific data, such as data for a particular market or region, and the clearinghouse can retrieve the selected data and provide it to the requesting party. A clearinghouse of the present invention may be local (e.g., where multiple system operators are in a particular market), regional, national, or international.

The systems and methods of the present invention may be advantageously implemented with the systems and methods disclosed in a patent application filed by Matz et al. on Dec. 14, 2001, entitled “System and Method for Utilizing Television Viewing Patterns,” (Attorney Docket No. 36968-265386 (BS01341)) which is incorporated herein by reference. Under embodiments disclosed therein, a subscriber's television viewing patterns are combined with programming and advertising media-content detail to determine the subscriber's content choices.

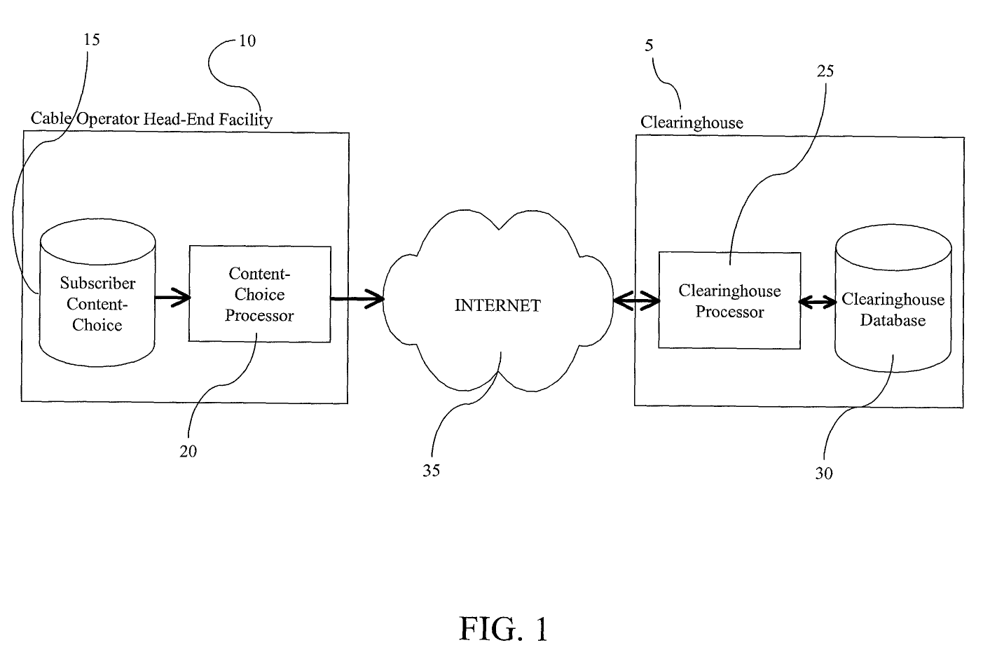

Referring now to the Figures, FIG. 1 is a schematic of an embodiment of the present invention for receiving subscriber content-choice information. In the embodiment shown, a clearinghouse 5 includes a clearinghouse processor 25, which is in communication with a clearinghouse database 30. The clearinghouse processor 25 is in communication with the Internet 35, and may collect data from the Internet and send data to the Internet.

Also, a cable operator head-end facility 10 includes a subscriber content-choice processor 20, which is in communication with a subscriber content-choice database 15 in the embodiment shown. The subscriber content-choice database 15 stores subscriber content-choice data received from the cable operator's subscribers. The subscriber content-choice processor is in communication with the Internet. While the databases and processors are shown separately at the clearinghouse 5 and at the cable operator head-end facility, the database and processor at each location may be software executing on a single piece of equipment.

The clearinghouse 5 collects subscriber content-choice data from the cable operator head-end facility 10. The subscriber content-choice data are stored in the subscriber content-choice database 15 based on data received from the cable operator's subscribers. The subscriber content-choice database 15 is in communication with the processor 20 to assist in the transfer of the subscriber content-choice data. The clearinghouse processor 25 assists in collecting the subscriber content-choice data, and the data are stored in the clearinghouse database 30.

In the embodiment shown, the data are transferred over the Internet 35. In other embodiments, the data may be transferred, for example, over the public switched telephone network (PSTN).

The subscriber content-choice data may be stored in any number of ways and may include data relating to the subscriber (e.g., the viewer or user), data relating to the subscriber system (e.g., the cable or satellite system operator), data relating to the programming viewed by the subscriber (e.g., the television programs), data relating to the advertising viewed by the subscriber, data relating to the viewing preferences of the subscriber, and data relating to the viewing patterns of the subscriber. Specifically, the subscriber content-choice data may include, for example, subscriber names, subscriber identification numbers/codes, subscriber geographic locations, subscriber demographic information (age, sex, race, religion, income, occupation, etc.), subscriber system names (e.g., cable or satellite system names), subscriber system locations, subscriber system identification numbers/codes, date identifiers, time identifiers, television program data (e.g., program name, genre, network/cable/premium program, etc.), advertisement data (manufacturer, brand, commercial length), radio program data, and Internet program data. The subscriber content-choice data may be in the form of subscriber content-choice records.

Subscriber content-choice data may also include subscriber content-choice summary data, such as data relating to the viewing preferences of the subscriber, data relating to the viewing preferences of a plurality of subscribers, data relating to the viewing patterns of the subscriber, and data relating to the viewing patterns of a plurality of subscribers.

A classification or category system may be established such that subscribers are assigned classifications or categories based on their past viewing histories. The classification system may include primary classifications and sub-classifications. These classifications or subscriber categories are additional examples of subscriber content-choice summary data.

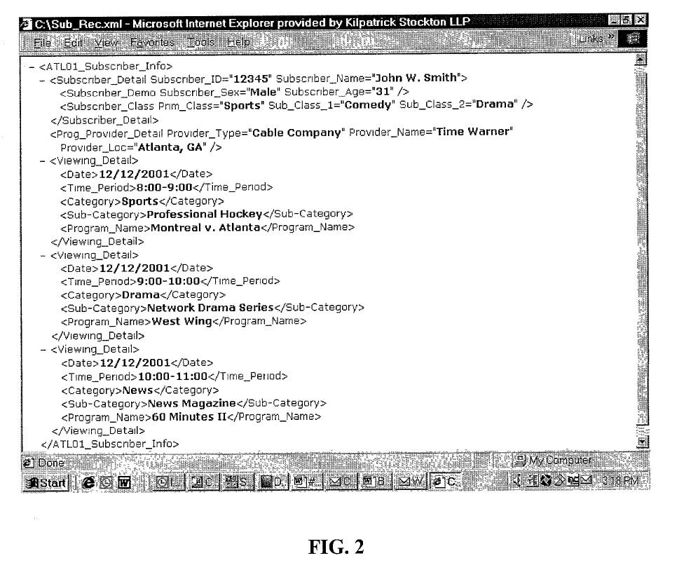

In one embodiment, the clearinghouse 5 provides specified formats for the data to be transferred from the cable operator head-end facility 10. For example, the clearinghouse may specify that the data be transferred as an extensible markup language (XML) file. FIG. 2 illustrates an example of an XML file containing subscriber content-choice data.

The XML file shown in FIG. 2 includes data relating to the subscriber (Subscriber_Detail), data relating to the subscriber system (Prog_Provider_Detail), data relating to the programming viewed by the subscriber (Viewing_Detail), and data relating to the viewing preferences of the subscriber (Subscriber_Class). The data relating to the subscriber include the subscriber's name (Subscriber_Name), the subscriber's identification code (Subscriber_ID), and demographic information relating to the subscriber (Subscriber_Demo). The data relating to subscriber system include the service provider type (Provider_Type) and provider name (Provider_Name).

The file summarizes the programming viewed by the subscriber on one day. The subscriber watched three television programs and each is summarized. The following data are provided for each program viewed: date viewed (Date), time viewed (Time_Period), program name (Program_Name), category (Category), and sub-category (Sub-Category). The categorical data for each program shown are preferably standardized, such that each television program is assigned the same category and sub-category.

The data relating to the viewing preferences of the subscriber (Subscriber_Class) include a primary classification (Prim_Class) and two sub-classifications (Sub_Class_{—}1 and Sub_Class_{—}2). A classification system is also preferably standardized such that, for example, classifications are consistently assigned to subscribers across different cable systems. This standardization of the classification system (and of the category system for television programs) provides another manner in which subscriber content-choice data may be aggregated, stored, and provided to requesting parties. The subscriber shown in FIG. 2 is primarily classified as a “Sports” viewer. In an example of a standardized classification system, this classification may indicate, for example, that the subscriber watches sports programming during 40% of his viewing time. The sub-classifications of “Comedy” and “Drama” may indicate that the subscriber watches situation comedies and dramas during another 10% of his viewing time.

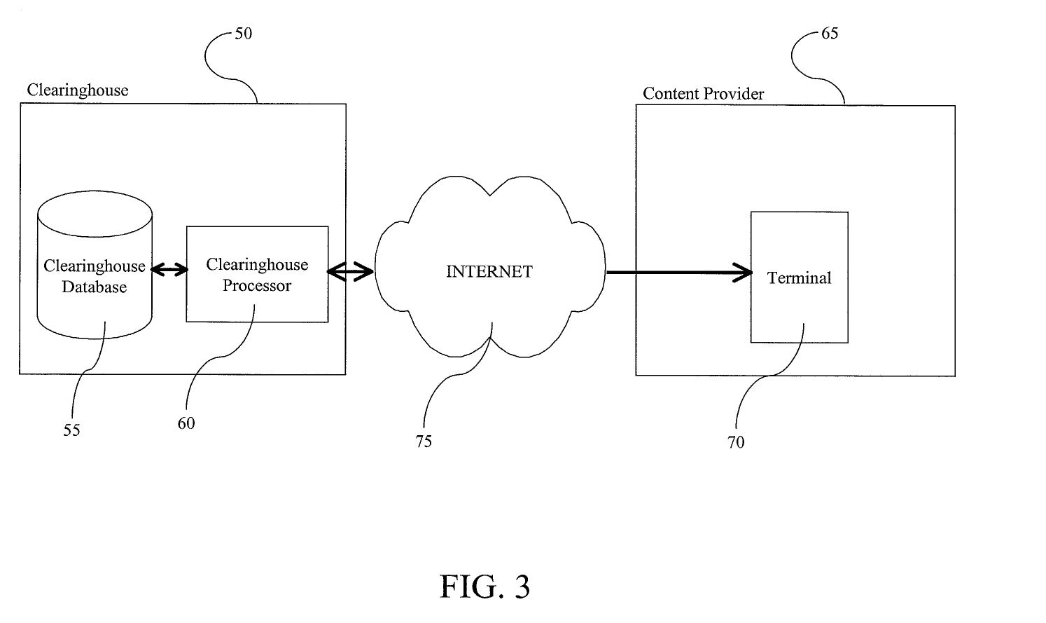

FIG. 3 is a schematic of an embodiment of the present invention for providing content-choice information to a content provider. The embodiment shown includes a clearinghouse 50 and a content provider 65, both of which are in communication with the Internet 75. In the embodiment shown, the clearinghouse 50 includes a clearinghouse processor 60, which is in communication with a clearinghouse database 55. The clearinghouse processor 60 is in communication with the Internet 75, and sends and receives data from the Internet 75. The content provider 65 includes a terminal 70. Examples of content providers include the major television networks, cable television networks, advertisers, product manufacturers, service providers, and advertising agencies.

In the embodiment shown, subscriber content-choice data have been received by the clearinghouse 50 from a plurality of cable operators and stored in the clearinghouse database 55. The content-choice data may be transferred from the clearinghouse 50 to the content provider 65.

The content provider 65 uses the terminal 70 to request certain subscriber content-choice data from the clearinghouse 50. The content provider 65 may request the data for a number of reasons and in a number of ways. For example, if a sports drink manufacturer is interested in advertising its products in the northeastern United States, the manufacturer may be interested in the location of the largest number of subscribers that are classified as “Sports” viewers. In this example, the subscriber content-choice data may be selected based on subscriber geographic location detail and based on subscriber classification.

As another example, a diaper manufacturer may be interested in determining on what day of the week soap operas receive the highest number of viewers in a particular market. In this example, the subscriber content-choice data may be selected based on date, based on geographic location, and based on program category.

In some embodiments, the clearinghouse 50 may provide a software program to each of the content providers which use its service that allows the content providers to submit requests for subscriber content-choice data using a standardized electronic request form. Using a standardized electronic request form enhances the electronic integration between the clearinghouse 50 and the content providers.

The clearinghouse 50 is able to sort and compile the subscriber content-choice data in its database 55 and provide it to the content provider 65 in a desirable format using its processor 60. The clearinghouse processor 60 receives the request for subscriber content-choice data and may query the clearinghouse database 55 to produce the selected content-choice data. The processor 60 may then compile and assemble the selected content-choice data before providing it to the content provider 65.

In other embodiments, the processor 60 may also analyze or summarize the selected content-choice data to provide content-choice data summaries to the content provider 65. For example, the content provider 65 may want to know the number of viewers in Raleigh, N.C. that are classified as “Sports” viewers. The clearinghouse processor 60 receives this request and formulates an appropriate query for the database 55.

As shown in FIG. 3, the selected subscriber content-choice data may be provided to the content provider 65 over the Internet. In other embodiments, the selected data may be transferred using the public switched telephone network (PSTN), using a dedicated phone line, and using wireless. The data are preferably securely provided to the content provider 65 using security techniques (e.g., encryption) known to those of ordinary skill in the art. The selected data may be displayed on the content provider terminal 70. Examples of terminals include, for example, personal computers, laptop computers, personal digital assistants, cellular telephones, and wireless communication devices. The selected data may be displayed on the terminal 70 using software (e.g., a browser) running on any of these devices and a communication channel. For example, the browser may submit a hypertext transfer protocol (“http”) request to a uniform resource locator (“URL”).

While the embodiment shown in FIG. 3 illustrates that the provision of subscriber content-choice data to content providers may be handled electronically, in other embodiments, a content provider may request the data by contacting an operator or by submitting the request in writing. The clearinghouse may print a hard copy of the selected subscriber content-choice data for transmittal to the content provider.

An embodiment of the present invention provides great value to content providers. As a result, content providers are willing to pay for the outputs derived from the various reports and analysis. The content providers may be billed a flat subscription-type rate for access to all information received or they may pay for each report and/or analysis that they request.

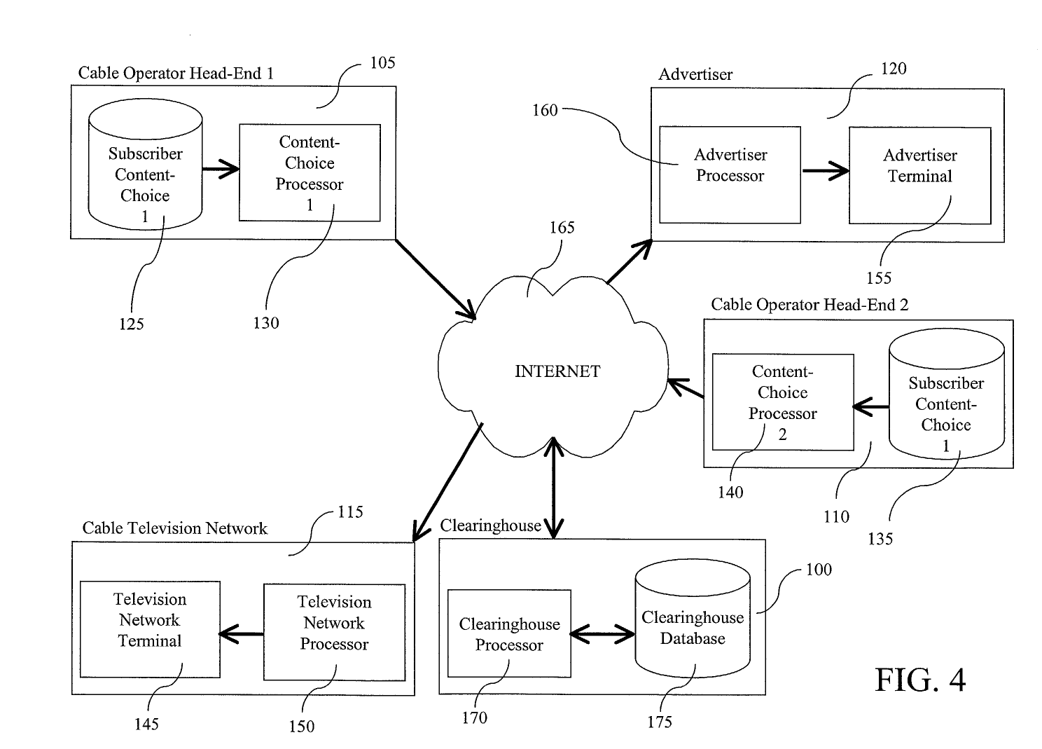

FIG. 4 is a schematic of an embodiment of the present invention for collecting content-choice information at a clearinghouse 100 and providing content-choice information to content providers 115,120. The clearinghouse 100 includes a clearinghouse processor 170, which is in communication with a clearinghouse database 175 in the embodiment shown. The content providers shown in FIG. 4 are a cable television network 115 and an advertiser 120. Each content provider 115,120 includes a processor 150,160, which is in communication with a terminal 145,155. In other embodiments, the terminal is in communication with the Internet and a processor is not necessary.

In the embodiment shown, the clearinghouse 100 collects subscriber content-choice data from a plurality of cable operator head-end facilities 105,110. Each head-end facility 105,110 comprises a subscriber content-choice database 125,135 and a subscriber content-choice processor 130,140. The subscriber content-choice databases receive and store subscriber content-choice data from the cable operators' subscribers. The clearinghouse 100 may collect the subscriber content-choice data from the cable operators 105,110 in a number of ways. For example, the cable operator may transfer the data at specified times. In other embodiments, the clearinghouse may periodically send requests for the data, which are then transferred to the clearinghouse from the cable operators.

The clearinghouse 100 may specify that the subscriber content-choice data be delivered in a particular form or format. In this embodiment, the content-choice processors 130,140 may compile, assemble, summarize, and/or analyze the subscriber content-choice data in the databases 125, 135 prior to delivering the data to the clearinghouse 100. For example, the clearinghouse 100 may require that only certain data are transferred and that the data are transferred in XML files. In the embodiment shown, the subscriber content-choice data are transferred to the clearinghouse 100 over the Internet. The data are preferably securely transferred to the clearinghouse 100 using security techniques (e.g., encryption) known to those of ordinary skill in the art.

The subscriber content-choice data are received by a clearinghouse processor 170. In various embodiments, the clearinghouse processor may convert the subscriber content-choice data to a different format, sort the data, compile the data, summarize the data, and/or analyze the data. The subscriber content-choice data are stored in a clearinghouse database 175.

In the embodiment shown in FIG. 4, a plurality of content providers are in communication with the clearinghouse 100. As noted above, the content providers shown are a cable television network 115 and an advertiser 120. Both content providers 115,120 may communicate with the clearinghouse 100 over the Internet. The cable television network 115 includes a television network terminal 145 and a television network processor 150. In some embodiments, the terminal and processor may be the same piece of equipment.

The cable television network 115 or the advertiser 120 may be interested in specific subscriber content-choice data for any number of reasons. For example, the cable television network may be interested in knowing the number of viewers of a particular broadcast that it had in a particular region. For example, if the cable television network produced a new documentary about the history of a particular city, the cable television network may be interested in knowing the number of viewers and the demographics of the viewers that watched it. To obtain such information, the cable television network 115 submits a request for subscriber content-choice data from its terminal 145 and processor 150 to the clearinghouse 100.

In some embodiments, the clearinghouse 100 may provide a software program to each of the content providers which use its service that allows the content providers to submit requests for subscriber content-choice data using a standardized electronic request form. Using a standardized electronic request form enhances the electronic integration between the clearinghouse 100 and the content providers.

The clearinghouse 100 is able to sort and compile the subscriber content-choice data in its database 175 and provide it to the television network 115 in a desirable format using its processor 170. The clearinghouse processor 170 receives the request for subscriber content-choice data and may query the clearinghouse database 175 to produce the selected content-choice data. The clearinghouse processor retrieves the selected subscriber content-choice data from the clearinghouse database 175. The processor 170 may then compile and assemble the selected content-choice data before providing it to the television network 115.

In other embodiments, the processor 170 may also analyze or summarize the selected content-choice data to provide content-choice data summaries to the television network 115.

As shown in FIG. 4, the selected subscriber content-choice data may be provided to the content providers 115,120 over the Internet 165. In other embodiments, the selected data may be transferred using the public switched telephone network (PSTN), using a dedicated phone line, and using wireless. The data are preferably securely provided to the content providers 115,120 using security techniques (e.g., encryption) known to those of ordinary skill in the art. The selected data may be displayed on the content provider terminals 145,155. Examples of terminals include, for example, personal computers, laptop computers, personal digital assistants, cellular telephones, and wireless communication devices.

The systems and methods of the present invention may be implemented in a number of ways using different computer equipment and operating platforms. For example, the databases may simply be a number of tables in relational databases. To simplify the process of querying the data, the databases may include online analytical processing tools, such as a multidimensional databases. The databases (e.g., clearinghouse database and subscriber content-choice databases) may be, for example, Microsoft SQL Server or Oracle Databases. The processors may be, for example, Sun or Intel-based servers, running operating systems such as Microsoft Windows or Linux.

The subscriber content-choice data may be transferred using a number of transfer methods, including, for example, transfer over the Internet, transfer over the PSTN, transfer over a dedicated phone line, or transfer using wireless technologies. The data may be transferred in a number of formats, including, for example, in XML files (see, e.g., FIG. 2), text files, comma separated values files (csv files), or other common file transfer formats.

If the subscriber content-choice data are transferred in XML files, the transfer may be executed in a number of ways. For example, if the subscriber content-choice database is a Microsoft SQL Server database, the database can provide the data to the processor in XML format. In other embodiments, the database may deliver the data to the subscriber content-choice processor, and the processor puts the data in an XML file. In other embodiments, the clearinghouse processor may collect the data from the subscriber content-choice processor and store them directly in the clearinghouse database.

The operator of the clearinghouse may specify to the cable system operators the format for the subscriber content-choice data to be collected. By insuring consistency among the cable system operators in the manner in which they provide the subscriber content-choice data, the clearinghouse may improve its efficiency in operating its database.

An embodiment of the present invention also relates to a computer-readable medium, having computer-readable instructions for collecting subscriber content-choice data from a plurality of subscriber content-choice databases and for storing the subscriber content-choice data in a clearinghouse database. The computer readable medium may also comprise computer-readable instructions for sorting the collected subscriber content-choice data.

In another embodiment, a computer-readable medium of the present invention includes computer-readable instructions for storing the subscriber content-choice data in a clearinghouse database, selecting stored subscriber content-choice data, and providing the selected subscriber content-choice data to a requesting party. The computer-readable medium may further comprise instructions for retrieving the selected subscriber content-choice data from the clearinghouse database and for securely providing the selected subscriber content-choice data to the requesting party.

A computer-readable medium includes an electronic, optical, magnetic, or other storage or transmission device capable of providing a processor, such as the processor in a web server, with computer-readable instructions. Examples of such media include, but are not limited to, a floppy disk, CD-ROM, magnetic disk, memory chip, or any other medium from which a computer processor can read. Also, various other forms of computer-readable media may transmit or carry instructions to a computer, including a router, private or public network, or other transmission device or channel.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

1. A method for receiving subscriber content-choice information, comprising:
collecting subscriber content-choice data from a plurality of subscriber content-choice databases; and
storing the subscriber content-choice data in a clearinghouse database.

2. The method of claim 1, wherein the subscriber content-choice data comprise data relating to viewing preferences of at least one subscriber.

3. The method of claim 2, wherein the subscriber content-choice data comprise data relating to television programs watched by the at least one subscriber.

4. The method of claim 3, wherein the subscriber content-choice data comprise date information and time information.

5. The method of claim 2, wherein the subscriber content-choice data further comprise data relating to the at least one subscriber.

6. The method of claim 5, wherein the data relating to the at least one subscriber comprise a subscriber identifier for each subscriber.

7. The method of claim 5, wherein the data relating to the at least one subscriber comprise demographic data for each subscriber.

8. The method of claim 2, wherein the subscriber content-choice data further comprise data relating to a subscriber system.

9. The method of claim 8, wherein the subscriber system comprises a cable system operator.

10. The method of claim 1, wherein the subscriber content-choice data comprise data relating to advertising viewed by at least one subscriber.

11. The method of claim 1, wherein the subscriber content-choice data comprise data relating to the viewing patterns of at least one subscriber.

12. The method of claim 1, wherein the subscriber content-choice data comprise at least one subscriber classification.

13. The method of claim 1, wherein the subscriber content-choice data comprise content-choice summary data.

14. The method of claim 1, further comprising sorting the collected subscriber content-choice data.

15. A method for receiving and distributing content-choice information, comprising:
collecting subscriber content-choice data from a plurality of subscriber content-choice databases;
storing the subscriber content-choice data in a clearinghouse database;
selecting stored subscriber content-choice data; and
providing the selected subscriber content-choice data to a requesting party.

16. The method of claim 15, wherein the subscriber content-choice data comprise data relating to viewing preferences of a plurality of subscribers.

17. The method of claim 16, wherein the subscriber content-choice data comprise data relating to television programs watched by the subscribers.

18. The method of claim 17, wherein the subscriber content-choice data comprises date information and time information.

19. The method of claim 17, wherein the subscriber content-choice data further comprise data relating to the subscribers.

20. The method of claim 19, wherein the data relating to the subscribers comprise a subscriber identifier for each subscriber.

21. The method of claim 19, wherein the data relating to the subscribers comprise demographic data for each subscriber.

22. The method of claim 17, wherein the subscriber content-choice data further comprise data relating to a subscriber system.

23. The method of claim 22, wherein the subscriber system comprises a cable system operator.

24. The method of claim 15, wherein the subscriber content-choice data comprise data relating to advertising viewed by the subscribers.

25. The method of claim 15, wherein the subscriber content-choice data comprise data relating to the viewing patterns of the subscribers.

26. The method of claim 15, wherein the subscriber content-choice data comprise at least one subscriber classification.

27. The method of claim 15, wherein the subscriber content-choice data 20 comprise content-choice summary data.

28. The method of claim 15, further comprising sorting the collected subscriber content-choice data.

29. The method of claim 15, further comprising retrieving the selected subscriber content-choice data from the clearinghouse database.

30. The method of claim 15, wherein the selected subscriber content-choice data are securely provided to the requesting party.

31. The method of claim 15, wherein the stored subscriber content-choice data are selected based on subscriber geographic location detail.

32. The method of claim 15, wherein the stored subscriber content-choice data are selected based on subscriber classification data.

33. The method of claim 15, wherein the stored subscriber content-choice data are selected based on data relating to television programs viewed by a plurality of subscribers.

34. The method of claim 15, wherein the stored subscriber content-choice data is selected based on data relating to advertisements viewed by a plurality of subscribers.

35. The method of claim 15, wherein the stored subscriber content-choice data are selected based on data relating to viewing date and geographic location.

36. A computer-readable medium on which is encoded computer program code for receiving subscriber content-choice information, comprising:
program code for collecting subscriber content-choice data from a plurality of subscriber content-choice databases; and
program code for storing the subscriber content-choice data in a clearinghouse database.

37. The computer-readable medium of claim 36, further comprising program code for sorting the collected subscriber content-choice data.

38. A computer-readable medium on which is encoded computer program code for receiving and distributing content-choice information, comprising:
program code for collecting subscriber content-choice data from a plurality of subscriber content-choice databases;
program code for storing the subscriber content-choice data in a clearinghouse database;
program code for selecting stored subscriber content-choice data; and
program code for providing the selected subscriber content-choice data to a requesting party.

39. The computer-readable medium of claim 38, further comprising program code for retrieving the selected subscriber content-choice data from the clearinghouse database.

40. The computer-readable medium of claim 38, further comprising program code for securely providing the selected subscriber content-choice data to the requesting party.

41. A system for receiving and distributing content-choice information, comprising:
a content-choice information clearinghouse, wherein the clearinghouse receives subscriber content-choice data and provides selected subscriber content-choice data to a requesting party.

42. The system of claim 41, wherein the clearinghouse comprises a database.

43. The system of claim 42, wherein the clearinghouse further comprises a processor.

44. The system of claim 41, wherein the clearinghouse receives the subscriber content-choice database from a plurality of subscriber content-choice databases.

45. The system of claim 41, wherein the selected subscriber content-choice data is provided to the requesting party over the internet.

46. A system for receiving and distributing content-choice information, comprising:
a content-choice information clearinghouse; and
a plurality of subscriber content-choice databases;
wherein the clearinghouse collects subscriber content-choice data from the plurality of subscriber content-choice databases and stores the subscriber content-choice data.

47. The system of claim 46, wherein the clearinghouse comprises a clearinghouse database.

48. The system of claim 47, wherein the clearinghouse further comprises a clearinghouse processor.

49. The system of claim 47, further comprising a content provider terminal.

50. The system of claim 49, wherein the clearinghouse provides selected subscriber content-choice data to the content provider terminal.
